(19) United States
(12) Patent Application Publication
(10) Pub. No.: US 2011/0220159 A1
(43) Pub. Date: Sep. 15, 2011

(54) Beverage Dispensing Gun Cleaning Apparatus

(76) Inventors: Dominic Joseph Ellickson, Waterford (IE); Darryl Kavanagh, Waterford (IE); Philip Brady, Watreford (IE)

(21) Appl. No.: 13/043,720

(22) Filed: Mar. 9, 2011

(30) Foreign Application Priority Data
Mar. 9, 2010 (IE) S2010/0146
Feb. 22, 2011 (IE) S2011/0086

(51) Int. Cl. B08B 3/00

(52) U.S. Cl. 134/198

(57) ABSTRACT

The apparatus includes a cylindrical cleaning chamber for reception of a dispensing head of a beverage dispensing gun. An associated cleaning device has a cleaning head located within the cleaning chamber for discharging cleaning fluid into the cleaning chamber for cleaning the dispensing head of the gun when the dispensing head is mounted within the cleaning chamber. The gun is engagable with a cradle to dock the dispensing head within the cleaning chamber for cleaning by the cleaning head.

### CROSS REFERENCE TO RELATED APPLICATIONS

This application claims priority from Irish Patent Application No. S2010/0146 filed on Mar. 9, 2010 and Irish Patent Application No. S2011/0086 filed on Feb. 22, 2011, the entire contents of each priority application incorporated herein by reference.

### INTRODUCTION

This invention relates to the cleaning of beverage dispensers, and in particular to the cleaning of hand-held soda gun type beverage dispensers.

Soda gun type beverage dispensers are now widely used in bars, restaurants and the like, for dispensing various flavoured soda drinks and mixers. These guns essentially comprise a hand-held body with a dispensing head having a number of dispensing nozzles which discharge into a spout for directing a selected beverage into a glass, paper cup or the like. A number of selector buttons on the gun are operable to select the drink to be dispensed from the associated nozzle. Operation of a trigger on the gun controls discharge of the selected beverage from the gun into the glass. A flexible hose attached to the gun connects each dispensing nozzle to an associated remote beverage reservoir. Bacterial growth can occur on the dispensing head about the nozzles and spout which may be exacerbated due to the fact that these guns can sit idle for long periods of time between uses.

The present invention is directed towards overcoming these problems.

### SUMMARY OF THE INVENTION

According to the invention, there is provided a beverage dispensing gun cleaning apparatus including a cleaning chamber for reception of a dispensing head of a beverage dispensing gun and a cleaning device for delivering a cleaning fluid into the cleaning chamber for cleaning the dispensing head.

In one embodiment of the invention, the cleaning device has a cleaning head mounted in the cleaning chamber for delivering cleaning fluid into an interior and onto an exterior of a spout of the dispensing head.

In another embodiment, the cleaning device has a cleaning head with inner discharge nozzles for directing cleaning fluid towards an exterior of the spout and one or more outer discharge nozzles engagable within the spout to direct cleaning fluid into the spout.

In another embodiment, the cleaning chamber is mounted on a cradle for reception of the beverage dispensing gun.

In a further embodiment, a sensor is mounted on the cradle which is operable to detect the presence of the gun on the cradle, said sensor being connected to a controller which is also connected to the cleaning device for operation of the cleaning device in response to mounting a gun on the cradle.

In another embodiment, the controller is operable to actuate the cleaning device at preset time intervals while the gun is resting on the cradle.

In another embodiment, the cleaning device includes a cleaning fluid reservoir and a pump having an inlet connected to the cleaning fluid reservoir and an outlet connected to the cleaning head.

In a further embodiment a docking system is provided for releasably engaging the gun with the cradle with the dispensing head of the gun located within the cleaning chamber.

In another embodiment the docking system includes an associated pair of magnets, namely a first magnet mounted on the gun and an associated second magnet mounted on the cradle, magnetic attraction between the magnets retaining the gun on the cradle when the gun is mounted on the cradle.

In another embodiment the docking system includes a saddle on the cradle for reception of a body of the gun when the gun is mounted on the cradle.

In another embodiment the sensor is mounted on the cradle such that the magnetic field generated by the magnets when the gun is mounted on the cradle activates the sensor to indicate the presence of the gun on the cradle to the controller.

In a further embodiment the cleaning head has a stepped configuration comprising an inner portion with a pipe extending outwardly therefrom, the inner portion having an internal bore forming a cleaning fluid passage, at least one inner discharge nozzle communicating between said bore and an exterior of the inner portion adjacent an inner end of the pipe for directing cleaning fluid outwardly into the cleaning chamber about the spout of the discharge head of the gun, the bore in the inner portion being connected to a cleaning fluid passage extending through the pipe and terminating in at least one outer discharge nozzle at an outer free end of the pipe which is engagable within the spout of the dispensing head of the gun.

In another embodiment a plurality of spaced-apart inner discharge nozzles are provided having outlets adjacent the inner end of the pipe.

In another embodiment a plurality of spaced-apart outer discharge nozzles are provided at the outer end of the pipe.

In another embodiment there is provided a beverage dispensing gun cleaning apparatus comprising:
a cradle for reception of the beverage dispensing gun,
a cleaning chamber mounted on the cradle for reception of a dispensing head of the beverage dispensing gun when said beverage dispensing gun is mounted on the cradle,
a cleaning head mounted in the cleaning chamber, said cleaning head having a number of spaced-apart discharge nozzles for delivering cleaning fluid into an interior of a spout of the dispensing head of the gun and onto an exterior of the spout,
a sensor mounted on the cradle, said sensor being operable to detect the presence of a gun on the cradle,
said sensor being connected to a controller, said controller operably connected to a pump mounted in a cleaning fluid supply line communicating between a cleaning fluid reservoir and the cleaning head,
the controller being operable to run the pump for a preset time period in response to detection of a gun on the cradle to deliver cleaning fluid to the cleaning head in the cleaning chamber.

### BRIEF DESCRIPTION OF THE DRAWINGS

The invention will be more clearly understood by the following description of some embodiments thereof, given by way of example only, with reference to the accompanying drawings, in which:

FIG. 1 is a schematic partially sectioned elevational view of a beverage dispensing gun cleaning apparatus according to the invention, shown with a beverage dispensing gun mounted thereon;

FIG. 2 is a schematic diagram of the beverage dispensing gun cleaning apparatus;

FIG. 3 is a perspective view showing a cradle portion of the beverage dispensing gun cleaning apparatus;

FIG. 4 is a detail sectional view showing a cleaning chamber portion of the beverage dispensing gun cleaning apparatus; and

FIG. 5 is a detail sectional view showing a cleaning head portion of the beverage dispensing gun cleaning apparatus.

### DETAILED DESCRIPTION OF PREFERRED EMBODIMENTS

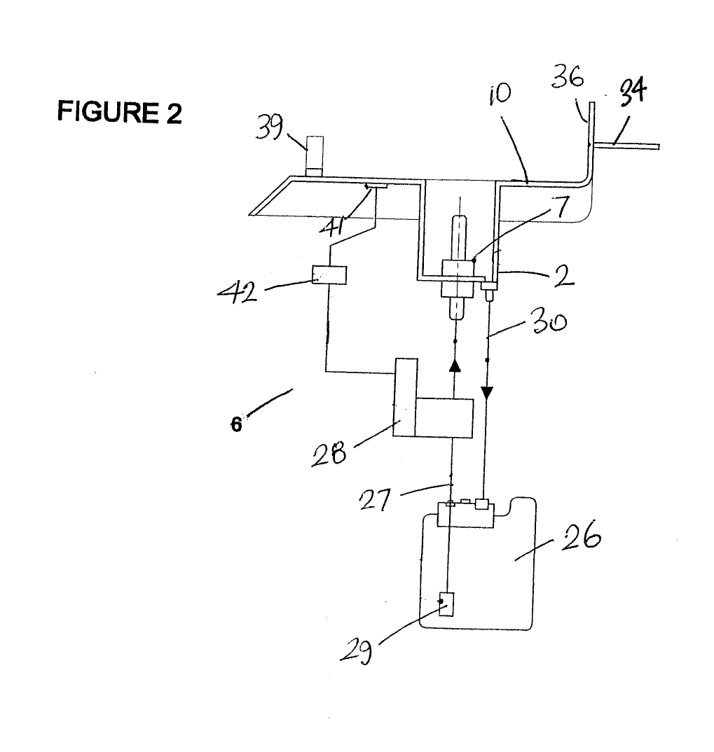

Referring to the drawings, there is illustrated a beverage dispensing gun cleaning apparatus according to the invention, indicated generally by the reference numeral 1. The apparatus 1 includes a cylindrical cleaning chamber 2 for reception of a dispensing head 3 of a beverage dispensing gun 4. A cleaning device, indicated generally by the reference numeral 6 (FIG. 2), has a cleaning head 7 located within the cleaning chamber 2 for discharging cleaning fluid into the cleaning chamber 2 for cleaning the dispensing head 3 of the gun 4 when the dispensing head 3 is mounted within the cleaning chamber 2. The gun 4 is engagable with a cradle 10 to dock the dispensing head 3 within the cleaning chamber 2 for cleaning by the cleaning head 7.

The beverage dispensing gun 4 shown in the drawings is typical of these types of beverage dispensing guns and essentially comprises a hand-held body 12 terminating in the dispensing head 3 which has a plurality of spaced-apart beverage dispensing nozzles 14 which discharge into an associated spout 15 for directing a selected beverage into a glass or the like. Selector buttons 16 on the body 12 are operable to select a desired beverage for dispensing through the spout 15. A flexible hose 18 with a number of internal beverage supply lines connects each nozzle 14 to an associated beverage reservoir.

The cleaning head 7 is of stepped configuration having an inner portion 20 with an array of inner discharge nozzles 21 for directing cleaning fluid towards an exterior of the spout 15. A central pipe 22 of the cleaning head 7 projects outwardly from the inner portion 20 and terminates in a number of outer discharge nozzles 23. This pipe 22 is engagable within the spout 15 so that the outer discharge nozzles 23 direct cleaning fluid into the interior of the spout 15 and about the outlets of the nozzles 14.

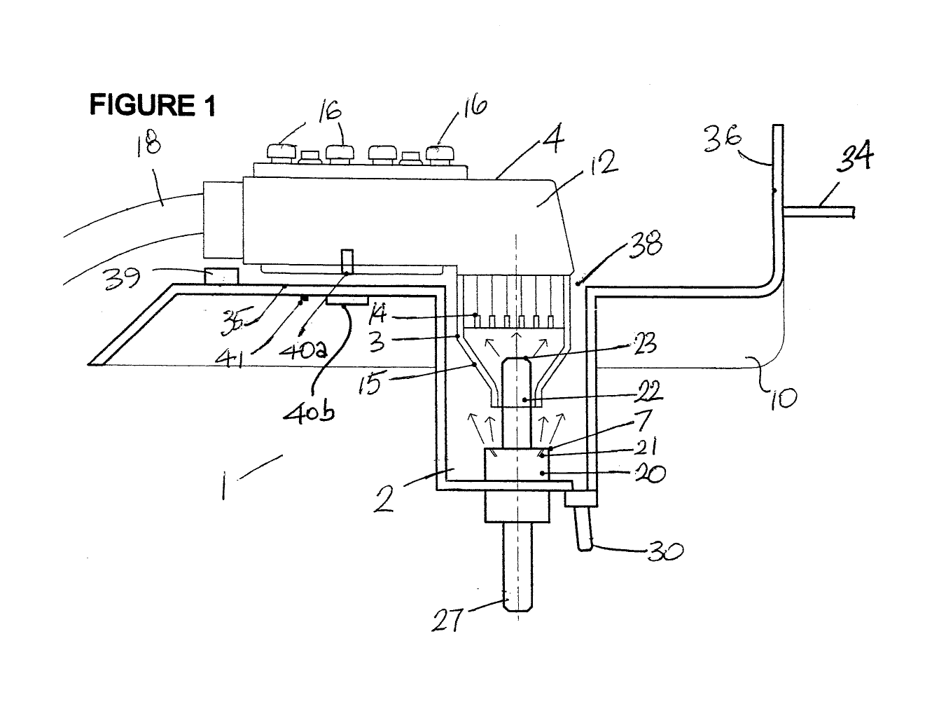

Referring in particular to FIG. 5, the inner portion 20 of the cleaning head 7 comprises a cylindrical block 24 having a central internal stepped bore 25 forming a passage for cleaning fluid. The stepped bore 25 has an inlet chamber 50 extending partially through the block 24 which narrows to a central cleaning fluid port 51 which communicates with the pipe 22. The inner discharge nozzles 21 communicate between the inlet chamber 50 and a top face 52 of the block 24 adjacent an inner end of the pipe 22. As can be seen in FIG. 5, these inner discharge nozzles 21 are angled outwardly relative to a central axis A of the cleaning head 7 and in use direct cleaning fluid outwardly as shown in FIG. 1 into the cleaning chamber 2 and about an exterior of the spout 15.

The pipe 22 has a bore forming a cleaning fluid passage 54. An inner end of the cleaning fluid passage 54 communicates with the cleaning fluid port 51. A closed outer free end 55 of the pipe 22 has the outer discharge nozzles 23 extending therethrough. These outer discharge nozzles 23 include a central nozzle coincident with the central axis A and outwardly angled side nozzles to provide a good distribution of cleaning fluid within an interior of the spout 15 as shown in FIG. 1.

Referring in particular to FIG. 2, the cleaning device 6 includes a cleaning fluid reservoir 26. A cleaning fluid supply line 27 connects between the cleaning fluid reservoir 26 and the cleaning head 7. A pump 28 is mounted in the cleaning fluid supply line 27. A non-return valve 29 is provided at an inlet of the cleaning fluid supply line 27. A drainpipe 30 connects between the cleaning chamber 2 and the cleaning fluid reservoir 26 for draining cleaning fluid from the cleaning chamber 2 back to the cleaning fluid reservoir 26.

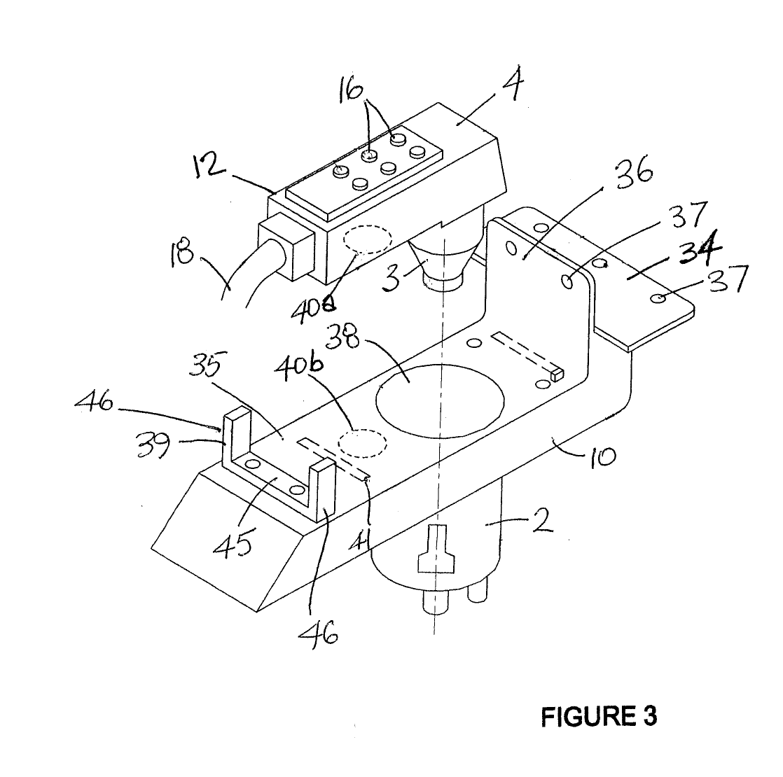

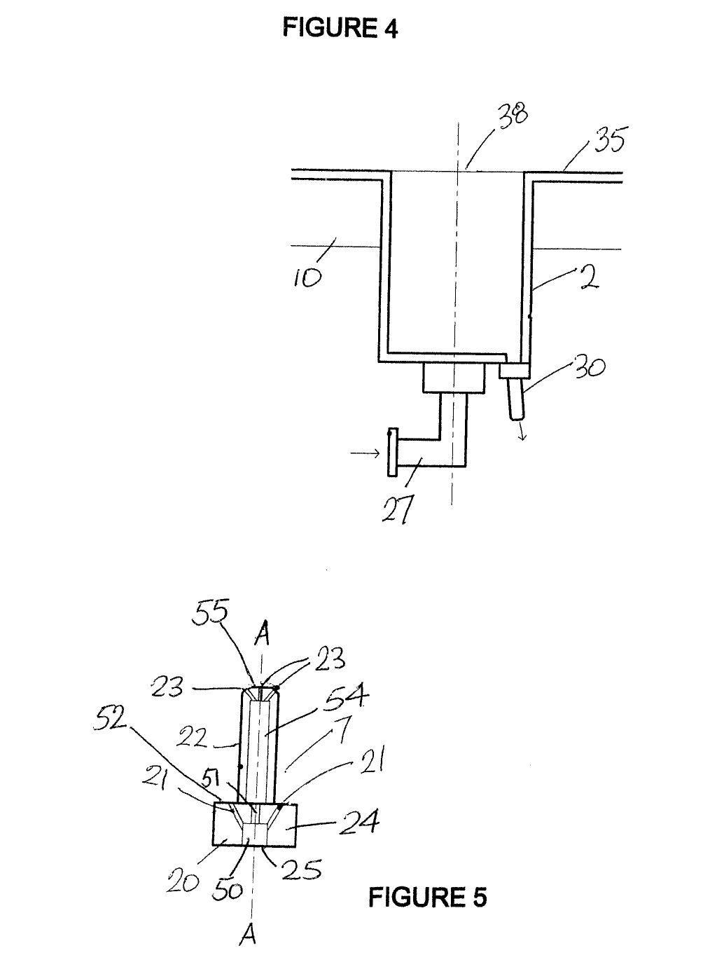

Referring in particular to FIG. 3, the cradle 10 for the beverage dispensing gun 4 is shown. The cradle 10 is L-shaped having a gun receiving platform 35 with an upwardly extending mounting flange 36 at one end of the platform 35. Through holes 37 for mounting screws are provided in the flange 36. A mounting plate 34 extends horizontally outwardly from the flange 36 and is substantially perpendicular thereto. This mounting plate 34 also has through holes 37 for mounting screws. This arrangement of mounting flange 36 and mounting plate 34 allows the cradle 10 to be secured at the edge of a worktop with the flange 36 engaging a vertical outer face of the worktop edge and the mounting plate 34 engaging against an underside of the worktop. An opening 38 in the platform 35 allows through passage of the dispensing head 3 of the gun 4 into the cleaning chamber 2. The cleaning chamber 2 is attached to an underside of the platform 35 beneath this opening 38.

A docking system for releasably engaging the gun 4 with the cradle 10 includes two magnets 40 which are fitted to the device as follows. A first magnet 40a is mounted on the underside of the gun 4 and an associated second magnet 40b is mounted on the underside of platform 35. When the gun 4 is mounted on the cradle 10 with the dispensing head 3 located in the cleaning chamber 2, the two magnets 40a, 40b align and create an attraction which holds the gun 4 firmly in place on the platform 35. When this occurs, the magnetic field around the magnets 40a, 40b active a reed switch sensor 41 mounted under the platform 35 and adjacent to the magnets 40a, 40b. Locating the gun 4 is further enhanced by a saddle 39 which prevents the gun 4 from moving sideways on platform 35. The saddle 39 has a U-shaped body comprising an inner portion 45 secured to the platform 35 and outwardly extending spaced-apart arms 46 for reception of an inner end of the body 12 of the gun 4.

The sensor 41 is connected to a controller 42 (FIG. 2) which is operably connected to the pump 28. Thus, when the sensor 41 detects the presence of a gun 4 on the cradle 10, the controller 42 operates the pump 28 to deliver pressurised cleaning fluid to the cleaning head 7 for cleaning the dispensing head 3 of the gun 4. Preferably also, the controller 42 includes a timer such that if the gun 4 is resting on the cradle 10 for a preset time period, say thirty minutes, then the controller 42 will operate the cleaning device 6 to again clean the dispensing head 3 of the gun 4. Time delay and periods on and off are independently adjustable within the controller 42.

Any suitable cleaning fluid may be used which is safe for humans, for example hypochlorous acid in a required concentration to sanitise the dispensing head 3 in a relatively short period—say about three to ten seconds.

In use, the beverage dispensing gun 4 after use is docked on the cradle 10 with the dispensing head 3 mounted within the cleaning chamber 2 as shown in FIG. 1. The sensor 41 detects the presence of the gun 4 and the controller 42 will operate the pump 28 for three or four seconds to deliver pressurised cleaning fluid from the reservoir 26 to the cleaning head 7 for discharge through the inner nozzles 21 to an exterior of the spout 15 and through the outer nozzles 23 within the spout 15 for cleaning an interior of the spout 15 and the nozzles 14 of the gun 4. The cleaning fluid will fall away for collection at a bottom of the cleaning chamber 2 from where it is drained via the drain pipe 30 back to the reservoir 26. It will be appreciated that the used cleaning fluid may be discharged to waste rather than being recycled to the reservoir 26 if desired. Repeated cleaning of the gun 4 every time the gun 4 is used will ensure that there is no build up of bacteria on the dispensing head 3 of the gun 4. The controller 42 will trigger a wash cycle if the gun 4 remains at rest on the cradle 10 for more than thirty minutes.

The invention is not limited to the embodiments hereinbefore described which may be varied in both construction and detail with the scope of the appended claims.

1. A beverage dispensing gun cleaning apparatus including a cleaning chamber for reception of a dispensing head of a beverage dispensing gun and a cleaning device for delivering a cleaning fluid into the cleaning chamber for cleaning the dispensing head.

2. The beverage dispensing gun cleaning apparatus as claimed in claim 1 wherein the cleaning device has a cleaning head mounted in the cleaning chamber for delivering cleaning fluid into an interior and onto an exterior of a spout of the dispensing head.

3. The beverage dispensing gun cleaning apparatus as claimed in claim 1 wherein the cleaning device has a cleaning head with inner discharge nozzles for directing cleaning fluid towards an exterior of the spout and one or more outer discharge nozzles engagable within the spout to direct cleaning fluid into the spout.

4. The beverage dispensing gun cleaning apparatus as claimed in claim 1 wherein the cleaning chamber is mounted on a cradle for reception of the beverage dispensing gun.

5. The beverage dispensing gun cleaning apparatus as claimed in claim 4 wherein a sensor is mounted on the cradle which is operable to detect the presence of the gun on the cradle, said sensor being connected to a controller which is also connected to the cleaning device for operation of the cleaning device in response to mounting a gun on the cradle.

6. The beverage dispensing gun cleaning apparatus as claimed in claim 5 wherein the controller is operable to actuate the cleaning device at preset time intervals while the gun is resting on the cradle.

7. The beverage dispensing gun cleaning apparatus as claimed in claim 1 wherein the cleaning device includes a cleaning fluid reservoir and a pump having an inlet connected to the cleaning fluid reservoir and an outlet connected to the cleaning head.

8. The beverage dispensing gun cleaning apparatus as claimed in claim 1 wherein a docking system is provided for releasably engaging the gun with the cradle with the dispensing head of the gun located within the cleaning chamber.

9. The beverage dispensing gun cleaning apparatus as claimed in claim 8 wherein the docking system includes an associated pair of magnets, namely a first magnet mounted on the gun and an associated second magnet mounted on the cradle, magnetic attraction between the magnets retaining the gun on the cradle when the gun is mounted on the cradle.

10. The beverage dispensing gun cleaning apparatus as claimed in claim 8 wherein the docking system includes a saddle on the cradle for reception of a body of the gun when the gun is mounted on the cradle.

11. The beverage dispensing gun cleaning apparatus as claimed in claim 5 wherein the sensor is mounted on the cradle such that the magnetic field generated by the magnets when the gun is mounted on the cradle activates the sensor to indicate the presence of the gun on the cradle to the controller.

12. The beverage dispensing gun cleaning apparatus as claimed in claim 3 wherein the cleaning head has a stepped configuration comprising an inner portion with a pipe extending outwardly therefrom, the inner portion having an internal bore forming a cleaning fluid passage, at least one inner discharge nozzle communicating between said bore and an exterior of the inner portion adjacent an inner end of the pipe for directing cleaning fluid outwardly into the cleaning chamber about the spout of the discharge head of the gun, the bore in the inner portion connected to a cleaning fluid passage extending through the pipe and terminating in at least one outer discharge nozzle at an outer free end of the pipe which is engagable within the spout of the dispensing head of the gun.

13. The beverage dispensing gun cleaning apparatus as claimed in claim 3 wherein a plurality of spaced-apart inner discharge nozzles are provided having outlets adjacent the inner end of the pipe.

14. The beverage dispensing gun cleaning apparatus as claimed in claim 3 wherein a plurality of spaced-apart outer discharge nozzles are provided at the outer end of the pipe.

15. A beverage dispensing gun cleaning apparatus comprising:
a cradle for reception of the beverage dispensing gun,
a cleaning chamber mounted on the cradle for reception of a dispensing head of the beverage dispensing gun when said beverage dispensing gun is mounted on the cradle,
a cleaning head mounted in the cleaning chamber, said cleaning head having a number of spaced-apart discharge nozzles for delivering cleaning fluid into an interior of a spout of the dispensing head of the gun and onto an exterior of the spout,
a sensor mounted on the cradle, said sensor being operable to detect the presence of a gun on the cradle,
said sensor being connected to a controller, said controller operably connected to a pump mounted in a cleaning fluid supply line communicating between a cleaning fluid reservoir and the cleaning head,
the controller being operable to run the pump for a preset time period in response to detection of a gun on the cradle to deliver cleaning fluid to the cleaning head in the cleaning chamber.
